(19) United States
(12) Patent Application Publication
(10) Pub. No.: US 2018/0211151 A1
(43) Pub. Date: Jul. 26, 2018

(54) INTENT DRIVEN SOLUTIONS IN CONNECTED ENVIRONMENTS

(71) Applicant: Essential Products, Inc., Palo Alto, CA (US)

(72) Inventors: Manuel Roman, Sunnyvale, CA (US); Mara Clair Segal, San Francisco, CA (US); Dwipal Desai, Palo Alto, CA (US); Andrew E. Rubin, Los Altos, CA (US)

(21) Appl. No.: 15/600,541

(22) Filed: May 19, 2017

Related U.S. Application Data
(60) Provisional application No. 62/450,690, filed on Jan. 26, 2017.
(60) Provisional application No. 62/486,410, filed on Apr. 17, 2017.

(51) Int. Cl. G06N 3/00; G05B 15/02; G10L 15/22; G10L 15/18

(52) U.S. Cl. CPC G06N 3/006; G05B 15/02; G10L 2015/223; G10L 15/1815; G10L 15/22

(57) ABSTRACT

Implementing functionality corresponding to an intent of speech is described. An assistant device can detect speech spoken within its environment. The assistant device can determine that the speech includes verbal content representing an intention regarding functionality within the environment. Devices capable of providing the functionality can be identified and used to provide that functionality.

### CLAIM FOR PRIORITY

This application claims priority to U.S. Provisional Patent Application No. 62/450,690 (Attorney Docket No. 119306-8056.US00), entitled “Intent Driven Solutions in Connected Environments,” by Roman et al., and filed on Jan. 26, 2017. This application also claims priority to U.S. Provisional Patent Application No. 62/486,410 (Attorney Docket No. 119306-8072.US00), entitled “Intent Driven Solutions in Connected Environments,” by Roman et al., and filed on Apr. 17, 2017. The content of the above-identified applications are incorporated herein by reference in their entirety.

### TECHNICAL FIELD

This disclosure relates to providing solutions to a user's intentions in a connected environment within a physical space such as a home, and in particular determining the user's intentions and the resources to provide a solution to the intention in the connected environment.

### BACKGROUND

The Internet of Things (IoT) allows for the internetworking of devices to exchange data among themselves to enable sophisticated functionality. For example, devices configured for home automation can exchange data to allow for the control and automation of lighting, air conditioning systems, security, etc.

In the smart home environment, this can also include home assistant devices providing an intelligent personal assistant to respond to speech. For example, a home assistant device can include a microphone array to receive voice input and provide the corresponding voice data to a server for analysis, for example, to provide an answer to a question asked by a user. The server can provide the answer to the home assistant device, which can provide the answer as voice output using a speaker. As another example, the user can provide a voice command to the home assistant device to control another device in the home, for example, a light bulb. As such, the user and the home assistant device can interact with each other using voice, and the interaction can be supplemented by a server outside of the home providing the answers. Improving the responsiveness of the home assistant device to the user is becoming increasingly important.

### SUMMARY

Some of the subject matter described herein includes a home assistant device, comprising: a microphone configured to receive speech including verbal content; one or more processors; and memory storing instructions, wherein the processor is configured to execute the instructions such that the processor and memory are configured to: determine that the verbal content of the speech includes an intention regarding a home automation activity within an environment; determine that one or more devices within the environment are capable of providing the home automation activity, each of the one or more devices communicatively coupled with the home assistant device via a wireless network; download software corresponding to the one or more devices; and implement the home automation activity using the one or more devices and the software.

Some of the subject matter described herein also includes an electronic device, comprising: one or more processors; and memory storing instructions, wherein the processor is configured to execute the instructions such that the processor and memory are configured to: determine that speech includes verbal content that represents an intention regarding functionality within an environment; determine that one or more devices within the environment are capable of providing at least a portion of the functionality; and provide at least a portion of the functionality using the one or more devices.

In some implementations, the one or more devices are connected on a wireless network with the electronic device.

In some implementations, providing at least a portion of the functionality includes downloading a software application configured to function with the one or more devices to provide the functionality.

In some implementations, the processor is configured to execute the instructions such that the processor and memory are configured to: determine that a portion of the functionality is not capable of being provided by the one or more devices within the environment; and provide an indication representing one or more devices that can provide the functionality.

In some implementations, the indication includes an opportunity to purchase the one or more devices that can provide the functionality.

In some implementations, the processor is configured to execute the instructions such that the processor and memory are configured to: determine that utilities within the environment are not configured to enable the functionality; and provide an indication representing available tradespeople that can modify the utilities within the environment to enable the functionality.

Some of the subject matter described herein also includes a method, comprising: determining that speech includes verbal content that represents an intention regarding functionality within an environment; determining, by a processor, that one or more devices within the environment are capable of providing at least a portion of the functionality; and providing at least a portion of the functionality using the one or more devices.

In some implementations, the one or more devices are connected on a wireless network with the electronic device.

In some implementations, providing at least a portion of the functionality includes downloading a software application configured to function with the one or more devices to provide the functionality.

In some implementations, the method includes determining that a portion of the functionality is not capable of being provided by the one or more devices within the environment; and providing an indication representing one or more devices that can provide the functionality.

In some implementations, the indication includes an opportunity to purchase the one or more devices that can provide the functionality.

In some implementations, the method includes: determining that utilities within the environment are not configured to enable the functionality; and providing an indication representing available tradespeople that can modify the utilities within the environment to enable the functionality.

Some of the subject matter described herein also includes a computer program product, comprising one or more non-transitory computer-readable media having computer program instructions stored therein, the computer program instructions being configured such that, when executed by one or more computing devices, the computer program instructions cause the one or more computing devices to: determine that speech includes verbal content that represents an intention regarding functionality within an environment; determine that one or more devices within the environment are capable of providing at least a portion of the functionality; and provide at least a portion of the functionality using the one or more devices.

In some implementations, the one or more devices are connected on a wireless network with the electronic device.

In some implementations, providing at least a portion of the functionality includes downloading a software application configured to function with the one or more devices to provide the functionality.

In some implementations, the computer program instructions cause the one or more computing devices to: determine that a portion of the functionality is not capable of being provided by the one or more devices within the environment; and provide an indication representing one or more devices that can provide the functionality.

In some implementations, the indication includes an opportunity to purchase the one or more devices that can provide the functionality.

In some implementations, the computer program instructions cause the one or more computing devices to: determine that utilities within the environment are not configured to enable the functionality; and provide an indication representing available tradespeople that can modify the utilities within the environment to enable the functionality.

### BRIEF DESCRIPTION OF THE DRAWINGS

FIG. 1 illustrates an example of an assistant device providing a solution to a user's intention.

FIG. 2 illustrates an example of a block diagram providing a solution to a user's intention.

FIG. 3 illustrates an example of another block diagram providing a solution to a user's intention.

FIG. 4 illustrates an example of an assistant device.

### DETAILED DESCRIPTION

This disclosure describes devices and techniques for an assistant device for determining a user's intentions for a connected environment and providing a solution to enact the user's intentions. In one example, an assistant device in a home can detect speech spoken to it. For example, the assistant device can include speakers and microphones so that it can interact with a user based on receiving speech from a user and provide output also as speech in response to the user's speech. The assistant device can also react to the user's speech if it includes commands. As an example, the user can request the assistant device to turn on or off lightbulbs in her connected environment (e.g., the user's home). The assistant device can determine the intention of the user's speech (e.g., turn on or off lights) and also determine the devices in the connected environment that can be used to act on the user's intention. The other devices can be accessible to the assistant device because they can use the same wireless network (e.g., implemented using one of the Institute of Electrical and Electronics Engineers (IEEE) 802.11 wireless standards). The assistant device can then download the appropriate software that can work with the devices in the connected environment to provide a solution that can enable the user's intention. Thus, in the previous example, the lights can be turned on or off using the assistant device. In another example, the assistant device can also provide the user with a listing of devices that the user can purchase to work within the connected environment to provide a solution.

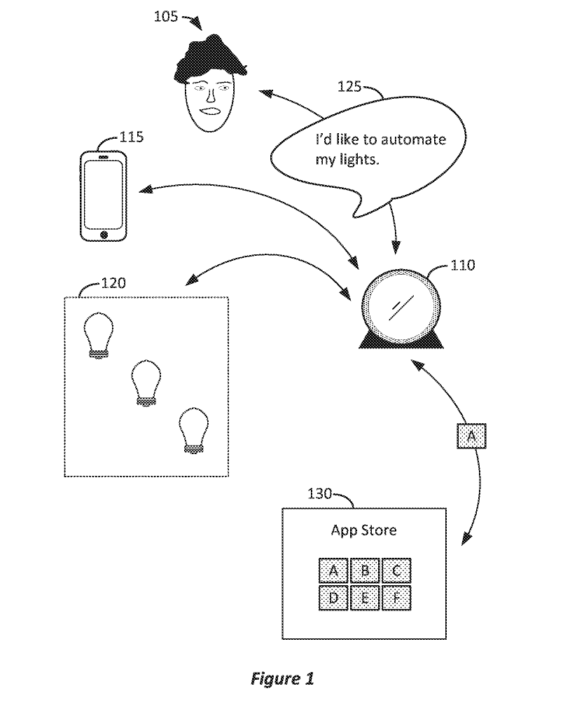

In more detail, FIG. 1 illustrates an example of an assistant device providing a solution to a user's intention. In FIG. 1, assistant device 110 can include a microphone (e.g., a microphone array) to receive voice input (or speech) from user 105 and a speaker to provide audio output in the form of speech (or other types of audio) to respond to user 105. Additionally, assistant device 110 can include a display screen to provide visual feedback to user 105. Additional visual components, such as light emitting diodes (LEDs), can also be included. As a result, the user interface can include audio, voice, display screen, and other visual components. In some implementations, a camera can also be included for assistant device 110 to receive visual input of its surrounding environment. The camera can be physically integrated (e.g., physically coupled with) with home assistant device 110 or the camera can be a separate component using a home's wireless network that can provide video data to assistant device 110.

In some implementations, user 105 can provide speech 125 including verbal content representing an intention or expectation of functionality for assistant device 110 to perform. For example, in FIG. 1, user 105 speaks speech 125, including a request to provide a home automation activity such as automate the lighting in the connected environment of a home including assistant device 110. Assistant device 100 can receive speech 125 using its microphone and analyze its verbal content (e.g., using speech recognition algorithms, provide speech 125 to a cloud server implementing speech recognition algorithms, etc.) to determine that it includes a request for automation of lights.

Assistant device 110 can then determine the devices in the connected home that should be controlled to automate the lighting, for example, light bulbs 120. That is, assistant device 110 can determine which devices in the connected environment should be interacted with to fulfill the functionality corresponding to speech 125. As an example, in FIG. 1, to automate the lighting of the connected environment, assistant device 110 can identify light bulbs 120 as being involved, but can determine that smartphone 115 is not used to automate the lighting. As a result, light bulbs 120 can be identified by assistant device 110 as devices that can be used to fulfill the functionality represented by speech 125.

Assistant device 110 might determine which devices can be capable of implementing the desired functionality because it can maintain a record of devices connected within the same wireless network that it uses. For example, assistant device 110, smartphone 115, and light bulbs 120 can be devices within a connected environment, for example, a home with a wireless local area network (WLAN) implementing one of the IEEE 802.11 standards. The devices can communicate with each other by using the wireless network to provide a connected environment of devices in the home. If the home includes a router providing a wireless network then many different devices can communicatively couple to that wireless network and, therefore, also communicate with each other. Assistant device 110 can maintain a database in memory representing the devices using the wireless network, associate devices with the functionality that they provide, etc.

Once assistant device 110 has determined the devices that can fulfill the functionality corresponding to speech 125, it can determine whether that functionality can be provided based on its current resources. For example, assistant device 110 might have software that can be used to provide a variety of functionality. If it cannot, then assistant device 110 can contact application store 130 to request software (e.g., an “app”) that can be downloaded and installed on assistant device 110 to provide the functionality. For example, in FIG. 1, assistant device 110 might not have the resources (e.g., software) to implement the functionality to automate the lighting of light bulbs 120. As a result, assistant device 110 can request application A from application store 130. Application A can provide the functionality to implement the automation of light bulbs 120. For example, application A might be software developed by the manufacturer or seller of light bulbs 120. Upon installing application A, assistant device 110 can then prompt user 105 on how she wishes to automate light bulbs 120 (e.g., the schedule, etc.). Accordingly, assistant device 110 can determine the intent of user 105, determine the devices within the connected environment that can be used to perform a solution for the intent, and download software that can be used with the devices. In some implementations, the software can be an “adapter” (or a driver) that allows for assistant device 110 to communicate with one or more of the devices and cause the corresponding devices to perform an action.

Sometimes, other types of resources can be missing or lacking in some way. If the user wants to automate lighting in her home, she might lack the hardware to do so. For example, she might not have lightbulbs that enable home automation and, therefore, an indication that the current lightbulbs installed are not capable of implementing the desired functionality can be provided. In some implementations, once a user intention is determined and assistant device 110 determines that no device within its environment is capable of performing that intention, then assistant device 110 can determine compatible devices that can be purchased and installed or setup within the home and suggest those devices to the user for purchase. Thus, an indication (e.g., a message displayed upon a display screen of assistant device 110) of hardware devices that can be used to implement the functionality can be provided. This can allow for the user to quickly be provided what devices can be purchased to enable the functionality, eliminating trial-and-errors such as accidentally purchasing a device that cannot implement the functionality. Thus, in some implementations, assistant device 110 can receive information regarding devices that are capable or compatible with the functionality from application store 130. In some implementations, assistant device 110 can also prompt the user to purchase one of the devices. In some implementations, the determination of compatible devices can include determining devices that are compatible with the operating system of assistant device 110, devices that are compatible with other devices within the home (e.g., devices that can interact together to fully implement the desired functional corresponding to the intention), etc.

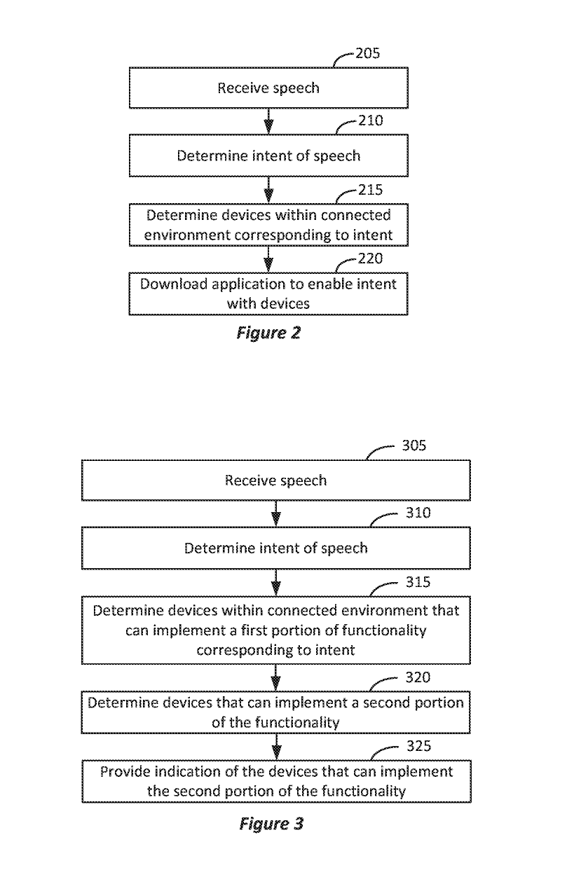

FIG. 2 illustrates an example of a block diagram providing a solution to a user's intention. In FIG. 2, at block 205, speech can be received by an assistant device. For example, in FIG. 1, assistant device 110 can receive speech 125. Assistant device can then process speech 125, for example, convert it into text, etc. At block 210, intent of the speech can be determined. For example, in FIG. 1, the intent of speech 125 can be determined by assistant device 110 to be that user 105 wishes to automate lighting within the connected environment. At block 215, devices within the connected environment corresponding to the intent can be determined. For example, in FIG. 1, assistant device 110 can determine that light bulbs 120 are within the connected environment and that they can be used for provide functionality for the intent. Assistant device 110 can determine that light bulbs 120 are within the connected environment by detecting their presence (e.g., they are all connected on the same wireless local area network (WLAN)), by looking up in memory data indicating that light bulbs 120 are within the connected environment, etc. At block 220, the assistant device can download a software application to enable functionality to provide the intent with the devices. For example, in FIG. 1, assistant device 110 can download application A from application store 130. Once installed or operational, application A can receive data from user 105 regarding how she wants light bulbs 120 to be automated (e.g., a schedule for turning on and off) and application A can also be run by assistant device 110 to interface with light bulbs 120 to provide the functionality.

In some implementations, user 105 can indicate what she wants to do and assistant device 110 can indicate the resources used to carry out that intent. For example, user 105 can indicate that she wants to see who is at her front door. Assistant device 110 can receive data indicating that intention (e.g., speech data indicating that user 105 wants to be able to see who is at her front door). Assistant device 110 can determine that a camera is not installed outside the front door, integrated within the peep hole, etc., and therefore it cannot determine who is at the front door. Assistant device 110 can then indicate to user 105 that she needs to purchase a camera if she wants to have that type of functionality in her connected environment. In some implementations, assistant device 110 can provide a listing of cameras that would work within the connected environment of user 105. For example, assistant device 110 can determine cameras that are compatible with itself and other devices within the connected environment and recommend one or more of those cameras for user 105 to purchase. In some implementations, assistant device 110 can select a camera itself and order the camera from a service (e.g., an online shopping website).

FIG. 3 illustrates an example of another block diagram providing a solution to a user's intention. In FIG. 3, at block 305, speech can be received and, at block 310, the intent of the speech can be determined. For example, as previously discussed, speech can be received using a microphone of assistant device 110 and that speech can be determined to include an intent to automate or implement some activity within the home. At block 315, devices within the connected environment that can implement a first portion of the functionality corresponding to the intent can be determined. For example, devices currently within the connected environment can be identified as capable of providing part of a solution to implement the functionality. Next, at block 320, devices that can implement a second portion of the functionality can be determined. For example, devices that are not within the connected environment but can be acquired can be determined. These devices can be capable of working with the devices determined at block 315 to implement the functionality that the user intends. Thus, at block 325, an indication as to the devices that can implement the second portion of the functionality can be provided. For example, a listing of devices can be displayed upon a graphical user interface (GUI) of a display screen of assistant device 110 indicating that these devices can be acquired to fulfill the functionality.

By indicating the software and hardware that can be used to provide functionality to enable the intention of user 105, assistant device 110 and application store 130 can provide a single solution indicating the hardware and software to implement that functionality. This can be in contrast with other scenarios where application stores are centered around software available for a device rather than also including hardware.

In some implementations, assistant device 110 can also indicate that a technician or tradesperson might be useful to set up, upgrade, or install utilities related to the desired functionality. For example, if user 105 indicates that she wants to have automated lighting in her connected environment, assistant device 110 can also recommend an electrician to come by to upgrade or repair the home such that light bulbs 120 can be installed to provide the functionality. In some implementations, assistant device 110 can store or access architectural blueprints, electrical schematics, plumbing information, etc. that can be analyzed to provide the recommendation. For example, if the electrical schematics indicate that the home's wiring is not set up to implement automated lighting, then assistant device 110 can determine this and provide a recommendation for an electrician.

In some implementations, assistant device 110 can determine the functionality that should be implemented based on the user's intention. However, sometimes that functionality cannot be performed due to missing hardware or other scenarios discussed above. But some of the devices within the home can implement portions of the functionality. That is, even though the functionality to fulfill the user's intention cannot be implemented, some functionality that can fulfill some or a part of the user's intention can be implemented. For example, if the user states that she wants to brew coffee, and the home has an electric kettle but no coffee grinder, then assistant device 110 can inform the user that brewing coffee cannot be automated, but that the heating of water for coffee using the electric kettle can be performed.

Many of the aforementioned examples discuss a home environment. In other examples, the devices and techniques discussed herein can also be set up in an office, public facility, etc.

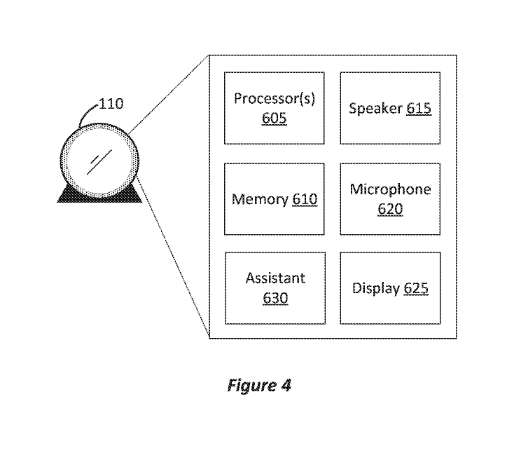

FIG. 4 illustrates an example of an assistant device. In FIG. 4, assistant device 105 includes a processor 605, memory 610, touchscreen display 625, speaker 615, microphone 635, as well as other types of hardware such as non-volatile memory, an interface device, camera, radios, etc. to implement assistant device logic 630 providing the techniques disclosed herein. Various common components (e.g., cache memory) are omitted for illustrative simplicity. The assistant device is intended to illustrate a hardware device on which any of the components described in the example of FIGS. 1-3 (and any other components described in this specification) can be implemented. The components of the assistant device can be coupled together via a bus or through some other known or convenient device.

The processor 605 may be, for example, a microprocessor circuit such as an Intel Pentium microprocessor or Motorola power PC microprocessor. One of skill in the relevant art will recognize that the terms “machine-readable (storage) medium” or “computer-readable (storage) medium” include any type of device that is accessible by the processor. Processor 605 can also be circuitry such as an application specific integrated circuits (ASICs), complex programmable logic devices (CPLDs), field programmable gate arrays (FPGAs), structured ASICs, etc.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk; a magnetic-optical disk; an optical disk; a read-only memory (ROM) such as a CD-ROM, EPROM, or EEPROM; a magnetic or optical card; or another form of storage for large amounts of data. Some of this data is often written, by a direct memory access process, into memory during the execution of software in the computer. The non-volatile storage can be local, remote or distributed. The non-volatile memory is optional because systems can be created with all applicable data available in memory. A typical computer system will usually include at least a processor, memory, and a device (e.g., a bus) coupling the memory to the processor.

The software can be stored in the non-volatile memory and/or the drive unit. Indeed, storing an entire large program in memory may not even be possible. Nevertheless, it should be understood that for software to run, it may be necessary to move the software to a computer-readable location appropriate for processing, and, for illustrative purposes, that location is referred to as memory in this application. Even when software is moved to memory for execution, the processor will typically make use of hardware registers to store values associated with the software and make use of a local cache that, ideally, serves to accelerate execution. As used herein, a software program is can be stored at any known or convenient location (from non-volatile storage to hardware registers).

The bus also couples the processor to the network interface device. The interface can include one or more of a modem or network interface. Those skilled in the art will appreciate that a modem or network interface can be considered to be part of the computer system. The interface can include an analog modem, an ISDN modem, a cable modem, a token ring interface, a satellite transmission interface (e.g., “direct PC”), or other interface for coupling a computer system to other computer systems. The interface can include one or more input and/or output devices. The input and/or output devices can include, by way of example but not limitation, a keyboard, a mouse or other pointing device, disk drives, printers, a scanner, and other input and/or output devices, including a display device. The display device can include, by way of example but not limitation, a cathode ray tube (CRT), a liquid crystal display (LCD), or some other applicable known or convenient display device.

In operation, the assistant device can be controlled by operating system software that includes a file management system, such as a disk operating system. The file management system is typically stored in the non-volatile memory and/or drive unit and causes the processor to execute the various acts required by the operating system to input and output data, and to store data in the memory, including storing files on the non-volatile memory and/or drive unit.

Some items of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electronic or magnetic signals capable of being stored, transferred, combined, compared, and/or otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, those skilled in the art will appreciate that throughout the description, discussions utilizing terms such as “processing” or “computing” or “calculating” or “determining” or “displaying” or “generating” or the like refer to the action and processes of a computer system or similar electronic computing device that manipulates and transforms data represented as physical (electronic) quantities within the computer system's registers and memories into other data similarly represented as physical quantities within the computer system's memories or registers or other such information storage, transmission, or display devices.

The algorithms and displays presented herein are not inherently related to any particular computer or other apparatus. Various general-purpose systems may be used with programs in accordance with the teachings herein, or it may prove convenient to construct more specialized apparatuses to perform the methods of some embodiments. The required structure for a variety of these systems will be apparent from the description below. In addition, the techniques are not described with reference to any particular programming language, and various embodiments may thus be implemented using a variety of programming languages.

In further embodiments, the assistant device operates as a standalone device or may be connected (e.g., networked) to other machines. In a networked deployment, the assistant device may operate in the capacity of a server or of a client machine in a client-server network environment or may operate as a peer machine in a peer-to-peer (or distributed) network environment.

In some embodiments, the assistant devices include a machine-readable medium. While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database and/or associated caches and servers) that store the one or more sets of instructions. The term “machine-readable medium” and “machine-readable storage medium” should also be taken to include any medium that is capable of storing, encoding, or carrying a set of instructions for execution by the machine, and which causes the machine to perform any one or more of the methodologies or modules of the presently disclosed technique and innovation.

In general, the routines executed to implement the embodiments of the disclosure may be implemented as part of an operating system or a specific application, component, program, object, module, or sequence of instructions referred to as “computer programs.” The computer programs typically comprise one or more instructions set at various times in various memory and storage devices in a computer that, when read and executed by one or more processing units or processors in a computer, cause the computer to perform operations to execute elements involving various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally, regardless of the particular type of machine- or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disc Read-Only Memory (CD-ROMS), Digital Versatile Discs, (DVDs), etc.), among others, and transmission type media such as digital and analog communication links.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice-versa. The foregoing is not intended to be an exhaustive list in which a change in state for a binary one to a binary zero or vice-versa in a memory device may comprise a transformation, such as a physical transformation. Rather, the foregoing is intended as illustrative examples.

A storage medium may typically be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe certain principles and practical applications, thereby enabling others skilled in the relevant art to understand the subject matter, the various embodiments and the various modifications that are suited to the particular uses contemplated.

While embodiments have been described in the context of fully functioning computers and computer systems, those skilled in the art will appreciate that the various embodiments are capable of being distributed as a program product in a variety of forms and that the disclosure applies equally regardless of the particular type of machine- or computer-readable media used to actually effect the distribution.

Although the above Detailed Description describes certain embodiments and the best mode contemplated, no matter how detailed the above appears in text, the embodiments can be practiced in many ways. Details of the systems and methods may vary considerably in their implementation details while still being encompassed by the specification. As noted above, particular terminology used when describing certain features or aspects of various embodiments should not be taken to imply that the terminology is being redefined herein to be restricted to any specific characteristics, features, or aspects of the disclosed technique with which that terminology is associated. In general, the terms used in the following claims should not be construed to limit the disclosure to the specific embodiments disclosed in the specification, unless those terms are explicitly defined herein. Accordingly, the actual scope of the technique encompasses not only the disclosed embodiments but also all equivalent ways of practicing or implementing the embodiments under the claims.

The language used in the specification has been principally selected for readability and instructional purposes, and it may not have been selected to delineate or circumscribe the inventive subject matter. It is therefore intended that the scope of the technique be limited not by this Detailed Description, but rather by any claims that issue on an application based hereon. Accordingly, the disclosure of various embodiments is intended to be illustrative, but not limiting, of the scope of the embodiments, which is set forth in the following claims.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A method for downloading software for a home assistant device providing Artificial Intelligence (AI) functionality within an environment, the software downloaded to implement an intention of a user providing speech indicating automation functionality to be performed within the environment using the home assistant device, comprising:
receiving speech indicating that the user has an intention to implement an automation functionality regarding devices within the environment to be performed using the home assistant device;
determining that one or more devices within the environment are capable of performing the automation functionality, the one or more devices communicatively coupled with the home assistant device via a wireless local area network (WLAN);
determining that software to implement the automation functionality is not currently set up with the home assistant device or not currently set up with the one or more devices within the environment that are capable of performing the automation functionality;
download the software corresponding to the automation functionality; and
perform the automation functionality using the software, the home assistant device, and the one or more devices within the environment that are capable of performing the automation functionality to fulfill the intention indicated in the speech of the user.

2. An electronic device, comprising:
one or more processors; and
memory storing instructions, wherein the processor is configured to execute the instructions such that the processor and memory are configured to:
determine that speech includes verbal content that represents an intention regarding functionality within an environment;
determine that one or more devices within the environment are capable of providing at least a portion of the functionality; and
provide at least a portion of the functionality using the one or more devices.

3. The electronic device of claim 2, wherein the one or more devices are connected on a wireless network with the electronic device.

4. The electronic device of claim 2, wherein providing at least a portion of the functionality includes downloading a software application configured to function with the one or more devices to provide the functionality.

5. The electronic device of claim 2, wherein the processor is configured to execute the instructions such that the processor and memory are configured to:
determine that a portion of the functionality is not capable of being provided by the one or more devices within the environment; and
provide an indication representing one or more devices that can provide the functionality.

6. The electronic device of claim 5, wherein the indication includes an opportunity to purchase the one or more devices that can provide the functionality.

7. The electronic device of claim 2, wherein the processor is configured to execute the instructions such that the processor and memory are configured to:
determine that utilities within the environment are not configured to enable the functionality; and
provide an indication representing available tradespeople that can modify the utilities within the environment to enable the functionality.

8. The electronic device of claim 2, wherein the functionality corresponds to an automation activity within the environment.

9. A method, comprising:
determining that speech includes verbal content that represents an intention regarding functionality within an environment;
determining, by a processor, that one or more devices within the environment are capable of providing at least a portion of the functionality; and
providing at least a portion of the functionality using the one or more devices.

10. The method of claim 9, wherein the one or more devices are connected on a wireless network with the electronic device.

11. The method of claim 9, wherein providing at least a portion of the functionality includes downloading a software application configured to function with the one or more devices to provide the functionality.

12. The method of claim 9, further comprising:
determining that a portion of the functionality is not capable of being provided by the one or more devices within the environment; and
providing an indication representing one or more devices that can provide the functionality.

13. The method of claim 12, wherein the indication includes an opportunity to purchase the one or more devices that can provide the functionality.

14. The method of claim 9, further comprising:
determining that utilities within the environment are not configured to enable the functionality; and
providing an indication representing available tradespeople that can modify the utilities within the environment to enable the functionality.

15. A computer program product, comprising one or more non-transitory computer-readable media having computer program instructions stored therein, the computer program instructions being configured such that, when executed by one or more computing devices, the computer program instructions cause the one or more computing devices to:
determine that speech includes verbal content that represents an intention regarding functionality within an environment;
determine that one or more devices within the environment are capable of providing at least a portion of the functionality; and
provide at least a portion of the functionality using the one or more devices.

16. The computer program product of claim 15, wherein the one or more devices are connected on a wireless network with the electronic device.

17. The computer program product of claim 15, wherein providing at least a portion of the functionality includes downloading a software application configured to function with the one or more devices to provide the functionality.

18. The computer program product of claim 15, the computer program instructions cause the one or more computing devices to:
determine that a portion of the functionality is not capable of being provided by the one or more devices within the environment; and
provide an indication representing one or more devices that can provide the functionality.

19. The computer program product of claim 18, wherein the indication includes an opportunity to purchase the one or more devices that can provide the functionality.

20. The computer program product of claim 15, the computer program instructions cause the one or more computing devices to:
determine that utilities within the environment are not configured to enable the functionality; and
provide an indication representing available tradespeople that can modify the utilities within the environment to enable the functionality.
